(19) United States
(12) Patent Application Publication
(10) Pub. No.: US 2026/0335921 A1
(43) Pub. Date: Oct. 29, 2026

(54) FLUID NOZZLE AND FLUID SYSTEM

(71) Applicant: 3M INNOVATIVE PROPERTIES COMPANY, St. Paul, MN (US)

(72) Inventors: Scott D. Gullicks, River Falls, WI (US); Ryan P. Marrinan, Lino Lakes, MN (US)

(21) Appl. No.: 19/114,318

(22) PCT Filed: Sep. 22, 2023
(86) PCT No.: PCT/IB2023/059414

§ 371 Date: Mar. 21, 2025

Related U.S. Application Data
(60) Provisional application No. 63/376,893, filed on Sep. 23, 2022.

(51) Int. Cl. B05B 15/62

(52) U.S. Cl. CPC B05B 15/62

(57) ABSTRACT

The fluid nozzle includes a tube including a first tube end and a second tube end opposite to the first tube end. The tube extends along a tube axis defined between the first tube end and the second tube end. The tube defines a first axis orthogonal to the tube axis and a second axis orthogonal to each of the tube axis and the first axis. The outlet is symmetric about each of the first axis and the second axis. The fluid nozzle further includes only one guide member extending from only one side of the tube along the first axis and aligned with the outlet width of the outlet. A portion of the only one guide member further extends beyond the first tube end along the tube axis.

### TECHNICAL FIELD

The present disclosure generally relates to a fluid system, and in particular, relates to a fluid nozzle for a fluid system.

### BACKGROUND

Vehicles, such as automobiles, typically include multiple external panels that are connected to a frame or a chassis. One or more gaps present between such panels may be filled with a seam sealer to prevent moisture, dirt, and the like from passing through the gaps and into an engine or passenger compartment of the vehicle. Such seam sealers can also provide sound damping to the vehicle. When one or more of these panels need to be replaced, the gaps between the panels are resealed by a technician. Oftentimes, seam seals have a unique look or pattern that is associated with the original manufacturer of the vehicle. When replacing these seam seals, the technician may desire to replicate the look or pattern of the original seam seal.

The ability to replicate an original equipment manufacturer (OEM) applied seam seal may require the use of a spray applicator and materials that work in, or with, a particular type of the spray applicator. This phenomenon may require multiple spray applicators, fluid nozzles, and materials. Spray applicators are typically expensive and may be difficult to clean. Moreover, additional applicators may be needed to brush some material prior to applying a sprayed texture, or a bead pattern.

Conventionally, a dual cartridge system used for spraying a fluid mixture containing two fluid components includes a dual barrel cartridge unit or other source (e.g., five gallon pails, five fifty-five gallon drums) containing the two fluid component, a disposable static mixer which is connected to a fluid nozzle, and an air manifold which is connected to a supply of pressurized air. Alternatively, a single cartridge system used for spraying a single fluid component generally includes a single barrel cartridge unit or other source containing the single fluid component, a fluid nozzle connected to the single barrel cartridge unit, and an air manifold which is connected to a supply of pressurized air. Typically, for single cartridge systems, the static mixer is integral with the fluid nozzle. Hence, such fluid nozzles may not be usable with dual cartridge systems. Overall, fluid nozzles usable with dual cartridge systems are different in design from fluid nozzles usable with single cartridge systems, thereby increasing part numbers.

Currently, seam sealing applications require purchasing of separate fluid nozzles based on a type of application (such as, single cartridge systems and dual cartridge systems), which may lead to confusion and incorrect ordering, and may also lead to longer wait times for completing repairs.

Joints and gaps are typically filled with high viscosity fluids (e.g., using a sealer) for protection against leaks of water, air, etc. For example, gaps between various external panels (e.g., hemmed flanged panels) of a vehicle may be filled with a seam sealer to prevent moisture, dirt, etc., from passing through the gaps. In downstream repair or aftermarket applications, the gaps between such panels may need to be resealed by a technician. However, technicians have a difficult time replicating, or matching, the quality of sealing originally produced through expensive machinery that are programmed to have precise specifications for pressure, flow, volume, temperature, timing, positioning, viscosity, etc.

Possibility for human error (e.g., uneven bead height, width, or uniformity) in the field or in a repair shop increases especially with inexperienced technicians. Implementation often falls short of original equipment manufacturers capabilities, and this mismatch may be easily observed, such as in a repair assessment or insurance context. Therefore, there is a need for improved techniques to reproduce sealing that do not add time or material costs to repair or aftermarket restoration practices.

Current sealant applicators are non-rotatable, i.e., have inconsistent cross-section of an outlet of the sealant applicator with change in an orientation of the sealant applicator. Further, the current sealant applicators may not allow a user to hold the sealant applicator comfortably while applying the sealant and adjust for the numerous contours and shapes of the panels on which the sealant is being applied to.

Vehicles, such as automobiles typically include multiple external panels that are connected to a frame or chassis. Gaps between these panels can be filled with a seam sealer to prevent moisture, dirt, etc., from passing through the gaps and into engine and/or passenger compartments of the vehicle. In some cases, such seam sealers may also provide sound damping to the vehicle. When one or more of the panels need to be replaced, the gaps between such panels may be resealed by a user. Furthermore, when replacing the seam seals, the user may desire to replicate a look or pattern of original seam seals.

There are a variety of seam sealers available that have different compositions and viscosities. Conventional fluid nozzles may not be suitable for use with the different seam sealers. That is, conventional fluid nozzles may be specifically designed and suitable for use with a single seam sealer product. Further, conventional fluid nozzles may be unable to replicate a look or pattern of original seam seals when not used with the seam sealer that they are specifically designed for.

Therefore, there is a need for a fluid nozzle that is suitable for use with a variety of different seam sealers having different viscosities. Further, there is a need for a fluid nozzle that is able to replicate a look or pattern of original seam seals regardless of a difference in viscosities of different seam sealers.

Joints and gaps are typically filled with a seam sealer for sealings against leaks (e.g., of water, air, etc.). For example, gaps between various external panels (e.g., hemmed flanged panels) of a vehicle may be filled with the seam sealer to prevent moisture, dirt, etc., from passing through the gaps. In downstream repair or aftermarket applications, the gaps between such panels may be resealed by a technician. However, the technicians may have difficulty replicating or matching the quality of an original sealing.

In some cases, there may be a requirement of a wide and/or flat application of a material of the seam sealer to replicate the original sealing having a wide and/or flat appearance. In such applications, tooling or brushing of the applied material in order to achieve the wide and/or flat appearance may lead to air entrapment or contamination prior to curing of the seam sealer. This may also negatively impact paint application at a later point.

### SUMMARY

In one aspect, a fluid nozzle is described. The fluid nozzle includes a tube including a first tube end and a second tube end opposite to the first tube end. The tube extends along a tube axis defined between the first tube end and the second tube end. The tube defines a first axis orthogonal to the tube axis and a second axis orthogonal to each of the tube axis and the first axis. The tube further includes an outlet disposed at the first tube end. The outlet includes a first outlet end, a second outlet end opposing the first outlet end, an outlet width between the first outlet end and the second outlet end along the first axis, and an outlet height along the second axis. The outlet is symmetric about each of the first axis and the second axis. The tube further includes an inlet disposed at the second tube end. The tube further includes a fluid passageway disposed within the tube and extending from the inlet to the outlet. The fluid nozzle further includes only one guide member extending from only one side of the tube along the first axis and aligned with the outlet width of the outlet. A portion of the only one guide member further extends beyond the first tube end along the tube axis.

In another aspect, a fluid system is described. The fluid system includes a fluid nozzle. The fluid nozzle includes a tube including a first tube end and a second tube end opposite to the first tube end. The tube extends along a tube axis defined between the first tube end and the second tube end. The tube defines a first axis orthogonal to the tube axis and a second axis orthogonal to each of the tube axis and the first axis. The tube further includes an outlet disposed at the first tube end. The outlet includes a first outlet end, a second outlet end opposing the first outlet end, an outlet width between the first outlet end and the second outlet end along the first axis, and an outlet height along the second axis. The outlet is symmetric about each of the first axis and the second axis. The tube further includes an inlet disposed at the second tube end. The tube further includes a fluid passageway disposed within the tube and extending from the inlet to the outlet. The fluid nozzle further includes only one guide member extending from only one side of the tube along the first axis and aligned with the outlet width of the outlet. A portion of the only one guide member further extends beyond the first tube end along the tube axis. The fluid system further includes a fluid source connected to the fluid nozzle and disposed in fluid communication with the fluid passageway.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

Exemplary embodiments disclosed herein may be more completely understood in consideration of the following detailed description in connection with the following figures. The figures are not necessarily drawn to scale. Like numbers used in the figures refer to like components. However, it will be understood that the use of a number to refer to a component in a given figure is not intended to limit the component in another figure labeled with the same number.

FIG. 1 is a schematic exploded front perspective view of a fluid system including a fluid nozzle, a static mix nozzle, and a fluid source, according to an embodiment of the present disclosure;

FIG. 2 is a schematic rear perspective view of the fluid nozzle, according to an embodiment of the present disclosure;

FIG. 3 is a schematic front view of the fluid nozzle, according to an embodiment of the present disclosure;

FIG. 4 is a schematic top view of the fluid nozzle, according to an embodiment of the present disclosure;

FIG. 5 is a flow chart illustrating a method of using the fluid nozzle, according to an embodiment of the present disclosure;

FIG. 6A is a schematic side view of the fluid nozzle and the fluid source, according to an embodiment of the present disclosure;

FIG. 6B is a schematic perspective view of the fluid nozzle, the fluid source, and a component, according to an embodiment of the present disclosure;

FIG. 6C is a schematic perspective view of the fluid nozzle, the fluid source, and the component where a fluid is directed from the fluid source into the fluid nozzle, according to an embodiment of the present disclosure; and

FIG. 6D is a schematic perspective view of the fluid nozzle, the fluid source, and the component where the fluid is ejected through the fluid nozzle, according to an embodiment of the present disclosure.

### DETAILED DESCRIPTION

In the following description, reference is made to the accompanying figures that form a part thereof and in which various embodiments are shown by way of illustration. It is to be understood that other embodiments are contemplated and may be made without departing from the scope or spirit of the present disclosure. The following detailed description, therefore, is not to be taken in a limiting sense.

In the following disclosure, the following definitions are adopted.

As used herein, all numbers should be considered modified by the term “about”. As used herein, “a,” “an,” “the,” “at least one,” and “one or more” are used interchangeably.

The term “about”, unless otherwise specifically defined, means to a high degree of approximation (e.g., within +/−5% for quantifiable properties) but again without requiring absolute precision or a perfect match.

As used herein as a modifier to a property or attribute, the term “generally” or “typically”, unless otherwise specifically defined, means that the property or attribute would be readily recognizable by a person of ordinary skill but without requiring absolute precision or a perfect match (e.g., within +/−20 % for quantifiable properties).

The term “substantially”, unless otherwise specifically defined, means to a high degree of approximation (e.g., within +/−10% for quantifiable properties) but again without requiring absolute precision or a perfect match.

Terms such as same, equal, uniform, constant, strictly, and the like, are understood to be within the usual tolerances or measuring error applicable to the particular circumstance rather than requiring absolute precision or a perfect match.

As used herein, the terms “first” and “second” are used as identifiers. Therefore, such terms should not be construed as limiting of this disclosure. The terms “first” and “second” when used in conjunction with a feature or an element can be interchanged throughout the embodiments of this disclosure

As used herein, when a first material is termed as “similar” to a second material, at least 90 weight % of the first and second materials are identical and any variation between the first and second materials includes less than about 10 weight % of each of the first and second materials.

As used herein, “at least one of A and B” should be understood to mean “only A, only B, or both A and B”.

As used herein, the recitations of numerical ranges by endpoints include all numbers subsumed within that range as well as the endpoints (e.g., 1 to 5 includes 1, 1.5, 2, 2.75, 3, 3.80, 4, 5, etc.).

The term “coupled” or “connected” may include direct physical connections between two or more components, or indirect physical connections between two or more components that are connected together by one or more additional components. For example, a first component may be coupled to a second component by being directly connected together or by being connected by a third component.

Unless specified or limited otherwise, the terms “attached,” “connected,” “coupled,” and variations thereof, are used broadly and encompass both direct and indirect attachments, connections, and couplings.

As used herein, the term “configured to” and like is at least as restrictive as the term “adapted to” and requires actual design intention to perform the specified function rather than mere physical capability of performing such a function.

As used herein, the term “resilient deformation” refers to an elastic deformation of a component or a portion of the component upon application of a force. The component, when resiliently deformed, may have a deformed state. The component may not plastically deform in the deformed state. The component may return to its undeformed state upon removal of the force. The force may be applied by another component. An extent of the elastic deformation may depend upon a magnitude of the force applied.

In general, the present disclosure provides various embodiments of a fluid nozzle and a fluid system that includes the fluid nozzle. The fluid nozzle can include a tube and a manifold disposed around tube. Typically, original equipment manufacturer (OEM) seam-sealing techniques require time-consuming manual processes to provide seam seals that resemble original factory-applied seam seals. Such processes include using hand tools to physically create specific textures and patterns by manually changing the appearance. Further, such processes include the use of combs, modified plastic body filler spreaders, Scotch Brite™ scuff pads, or other tooling after dispensing sealer onto the surface; physically altering the dispensing through movements of the applicator, adjustment of air pressure using a trigger of a pneumatic applicator, or application of physical pressure of a manual applicator. Other techniques can also include, but are not limited to, cutting or manipulating the dispensing nozzles or selection of various sealing materials being utilized.

Conventionally, a dual cartridge system used for spraying a fluid mixture containing two fluid components includes a dual barrel cartridge unit or other source (e.g., five gallon pails, five fifty-five gallon drums) containing the two fluid component, a disposable static mixer which is connected to a fluid nozzle, and an air manifold which is connected to a supply of pressurized air. Alternatively, a single cartridge system used for spraying a single fluid component generally includes a single barrel cartridge unit or other source containing the single fluid component, a fluid nozzle connected to the single barrel cartridge unit, and an air manifold which is connected to a supply of pressurized air. Typically, for single cartridge systems, the static mixer is integral with the fluid nozzle. Hence, such fluid nozzles may not be usable with dual cartridge systems. Overall, fluid nozzles usable with dual cartridge systems are different in design from fluid nozzles usable with single cartridge systems, thereby increasing part numbers. Currently, seam sealing applications require purchasing of separate fluid nozzles based on a type of application (such as, single cartridge systems and dual cartridge systems), and may lead to confusion and incorrect ordering as well as longer wait times for completing repairs.

Therefore, there exists a need for a fluid nozzle that may be interchangeably connected to single cartridge systems as well as dual cartridge systems, thereby reducing part numbers and increasing efficiency of fluid systems that include fluid nozzles.

The present disclosure provides a fluid nozzle. The fluid nozzle includes a tube including a first tube end and a second tube end opposite to the first tube end. The tube extends along a tube axis defined between the first tube end and the second tube end. The tube includes an inlet defined at the first tube end. The tube includes an outlet defined at the second tube end. The tube further includes a fluid passageway disposed within the tube and extending from the inlet to the outlet. The tube further includes a first portion including the outlet. The first portion extends from the second tube end towards the first tube end along the tube axis. The first portion at least partially defines the fluid passageway therein. The tube further includes a second portion including the inlet. The second portion extends from the first portion to the first tube end along the tube axis. The second portion at least partially defines the fluid passageway therein. The second portion is configured to be selectively and removably connected to a first fluid source. The tube further includes a third portion extending from the first tube end towards the second tube end along the tube axis. The third portion at least partially surrounds and is connected to the second portion. The third portion includes a cylindrical section extending along a length of the third portion and at least one first coupling element disposed on the cylindrical section. The fluid nozzle further includes an adapter configured to be selectively and removably connected to the third portion of the tube when the first fluid source is disconnected from the second portion of the tube. The adapter defines an adapter channel that is in fluid communication with the fluid passageway when the adapter is connected to the third portion of the tube. The adapter is configured to be detachably connected to a second fluid source different from the first fluid source. The adapter includes a first adapter end, a second adapter end opposite to the first adapter end, an adapter axis extending between the first adapter end and the second adapter end, an inner surface, and an outer surface. The adapter is configured to at least partially receive the third portion of the tube therein through the first adapter end. The adapter includes at least one second coupling element disposed on the inner surface proximal to the first adapter end and extending angularly about the adapter axis. The at least one second coupling element is configured to at least partially receive the at least one first coupling element of the third portion therein to form a snap-fit connection between the adapter and the third portion. The tube is rotatable relative to the adapter about the tube axis upon connection with the adapter.

The fluid nozzle of the present disclosure may be used for dispensing high viscosity materials. The fluid nozzle as described herein may be interchangeably used with single cartridge systems and dual cartridge systems. More particularly, the present disclosure provides a modular fluid nozzle that may be quickly and easily connected to a mixer by a press-fit. The mixer may be in turn connected to a dual barrel cartridge unit. Alternatively, the modular fluid nozzle may be quickly and easily connected to the adapter by a snap-fit. Further, the adapter may be threadedly connected to a single barrel cartridge unit. As the modular fluid nozzle may be connected with two types of fluid systems, costs associated with handling and manufacturing of fluid nozzles with different part numbers may be eliminated. Further, the fluid nozzle may be disposable, thereby eliminating time required for cleaning and additional costs associated with cleaning solutions. Moreover, the fluid nozzle may be connectable with different designs of air manifolds and nozzle spray tips.

Further, the fluid nozzle of the present disclosure may reduce the number of applicators (and more specifically, fluid nozzles) that may be required to perform seam sealing applications to replicate OEM look and appearance, while increasing application efficiency, reducing waste, and creating a unique, no clean up solution for both single cartridge systems and dual cartridge systems.

According to aspects of this disclosure, a fluid nozzle includes a tube including a first tube end and a second tube end opposite to the first tube end. The tube extends along a tube axis defined between the first tube end and the second tube end. The tube defines a first axis orthogonal to the tube axis and a second axis orthogonal to each of the tube axis and the first axis. The tube further includes an outlet disposed at the first tube end. The outlet includes a first outlet end, a second outlet end opposing the first outlet end, an outlet width between the first outlet end and the second outlet end along the first axis, and an outlet height along the second axis. The outlet is symmetric about each of the first axis and the second axis. The tube further includes an inlet disposed at the second tube end. The tube further includes a fluid passageway disposed within the tube and extending from the inlet to the outlet. The fluid nozzle further includes only one guide member extending from only one side of the tube along the first axis and aligned with the outlet width of the outlet. A portion of the only one guide member further extends beyond the first tube end along the tube axis.

The fluid nozzle includes the one only guide member extending from the only one side of the tube along the first axis. The only one guide member may allow the fluid nozzle to be aligned with an edge of a component onto which a fluid may be applied and follow the edge while the fluid is extruded onto the component. Therefore, the only one guide member may guide the fluid nozzle as the fluid is extruded onto the component. Conventional fluid nozzle designs have dual guide members where the guide members extend from opposing sides of the tube. One of the guide members needs to be cut-off prior to use. However, in the present disclosure, only one guide member extends from only one side of the tube.

Additionally, the outlet is symmetric about each of the first axis and the second axis, thereby allowing for the same cross-sectional profile of the outlet regardless of whether the fluid nozzle is being used by a user in a left-handed or a right-handed orientation. Thus, the fluid nozzle of the present disclosure may reduce errors in application of the fluid by providing a consistent cross-section for the outlet regardless of the orientation of the fluid nozzle in which the user is applying the fluid. This is also possible since the one only guide member is disposed on only one side of the tube. Further, the outlet may allow extrusion of a consistent profile of the fluid onto the component. The symmetric cross-section of the outlet combined with the only one guide member may allow reduction in a time required for the application of the fluid by following the edge of the component as well as improve a quality of sealing.

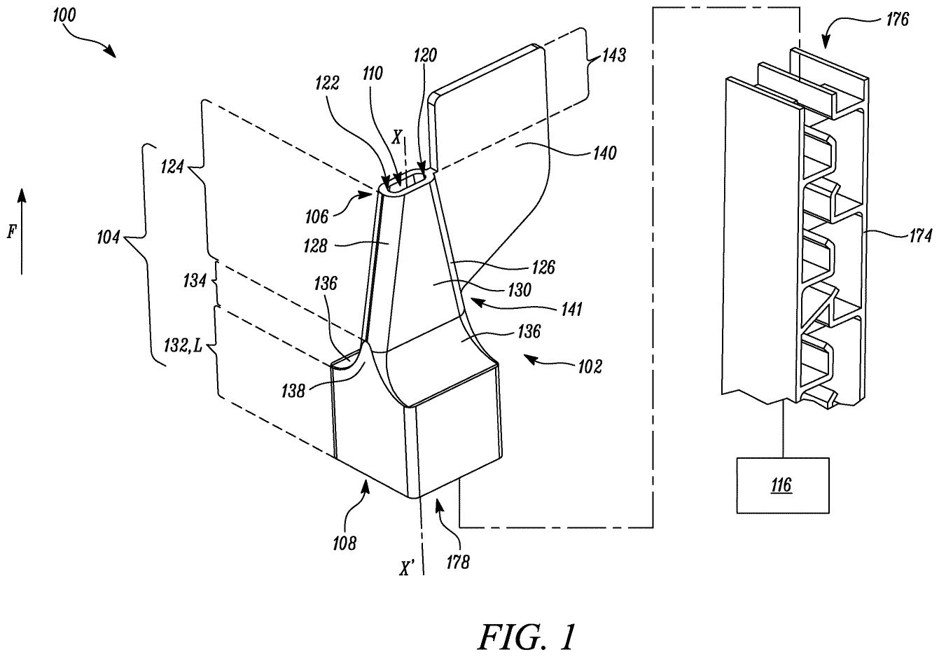

Referring now to Figures, FIG. 1 illustrates a schematic view of an example of a fluid system 100 including a fluid nozzle 102, a static mix nozzle 174, and a fluid source 116. Specifically, FIG. 1 illustrates a schematic front exploded perspective view of the fluid nozzle 102 and the static mix nozzle 174. The fluid source 116 is shown schematically in FIG. 1 for the purpose of illustration. The fluid nozzle 102 includes a tube 104 including a first tube end 106 and a second tube end 108 opposite to the first tube end 106. The tube 104 extends along a tube axis X-X′ defined between the first tube end 106 and the second tube end 108. The tube 104 further includes an outlet 110 disposed at the first tube end 106. The outlet 110 includes a first outlet end 120 and a second outlet end 122 opposing the first outlet end 120.

In some examples, the tube 104 may be made from any suitable material or a combination of materials, e.g., a polymeric material (e.g., injection molded plastics), a metallic material, a ceramic material, etc. Further, the tube 104 may be manufactured using any suitable technique or techniques, e.g., molding, 3D printing, forging, die casting, machining, stamping, vacuum forming, extrusion, etc. In some examples, the tube 104 may be integrally formed as a one-piece component.

The fluid system 100 further includes the fluid source 116 connected to the fluid nozzle 102. In some examples, the fluid nozzle 102 may dispense a fluid received from the fluid source 116. In some examples, the fluid source 116 may include any suitable fluid source or sources. In some examples, the fluid source 116 may include an associated plunger (not shown). In some examples, the plunger may be utilized to force the fluid (e.g., by applying pressure) through the fluid nozzle 102, thereby forcing the fluid through the outlet 110. In some examples, the fluid source 116 may include one or more chambers that may store one or more components of the fluid to be dispensed through the fluid nozzle 102.

In some examples, the fluid source 116 may include two chambers for storing fluid components. In some examples, the fluid components from the individual chambers may be mixed before dispensing through the fluid nozzle 102. For example, a static or dynamic mixer may be disposed between the fluid source 116 and the fluid nozzle 102 and may mix the fluid components together prior to directing the mixture into the fluid nozzle 102.

In the illustrated embodiment of FIG. 1, the fluid system 100 further includes the static mix nozzle 174 (i.e., a static mixer) that is configured to couple to the fluid source 116 and the fluid nozzle 102. Thus, the fluid source 116 is indirectly coupled to the fluid nozzle 102 through the static mix nozzle 174. Alternatively, in some other examples, the fluid source 116 may be directly coupled to the fluid nozzle 102 without the static mix nozzle 174 (e.g., through a threaded engagement, a press-fitting, a quarter-turn locking mechanism, etc.). It should be understood that the static mix nozzle 174 is shown in FIG. 1 by way of example only and the fluid system 100 may include any type of mixer.

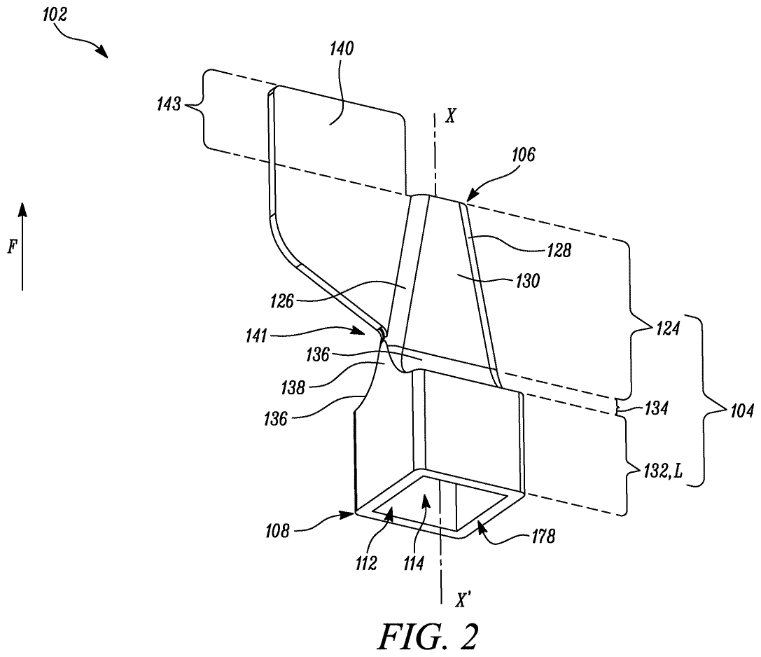

In some examples, the static mix nozzle 174 has a first shape profile 176. In some examples, the fluid nozzle 102 has a second shape profile 178 (also shown in FIG. 2) that is complementary to the first shape profile 176, such that the static mix nozzle 174 is mateable with the fluid nozzle 102. Specifically, the second tube end 108 of the fluid nozzle 102 has the second shape profile 178 that is complementary to the first shape profile 176 of the static mix nozzle 174, such that the second tube end 108 mates with the first shape profile 176 of the static mix nozzle 174. For example, the second tube end 108 is shown with a square profile (also shown in FIG. 2) to mate with a square profile of the static mix nozzle 174.

In some examples, the fluid from the fluid source 116 may include any suitable material or a combination of materials, e.g., seam sealers, epoxies, foams, adhesives (e.g., one or two-part adhesives), fillers, etc. It should be understood that any suitable seam sealing materials may be utilized, e.g., one-part and two-part seam sealers, urethane sealers, modified saline polymer sealers, two-part epoxy sealers, one-part and two-part acrylic sealers, viscous one-part and two-part moisture sealants, UV-cure sealants, blue-light-cure sealants, heat activated sealants, etc. Further, any suitable adhesives may be utilized, e.g., one-part and two-part acrylic adhesives, etc. In some examples, the fluid may be a high viscosity fluid (or other seam sealing compositions) that is adapted to seal one or more seams disposed between panels of a vehicle, or to seal seams present on interior or exterior surfaces of buildings.

FIG. 2 illustrates a schematic rear perspective view of the fluid nozzle 102. Referring to FIGS. 1 and 2, the tube 104 further includes an inlet 112 (shown in FIG. 2) disposed at the second tube end 108. In some examples, the fluid source 116 (shown in FIG. 1) is fluidly coupled to the inlet 112 of the tube 104. The tube 104 further includes a fluid passageway 114 disposed within the tube 104 and extending from the inlet 112 (shown in FIG. 2) to the outlet 110 (shown in FIG. 1). In some examples, the fluid source 116 (shown in FIG. 1) is disposed in fluid communication with the fluid passageway 114.

In some examples, the fluid passageway 114 disposed within the tube 104 may have any suitable shape or shapes and may have any suitable dimensions based on application requirements. In some examples, the fluid passageway 114 may have a polygonal cross-section in a plane orthogonal to the tube axis X-X′. Further, in some examples, a portion of the fluid passageway 114 has a constant cross-sectional area as measured in the plane orthogonal to the tube axis X-X′. In some examples, a portion of the fluid passageway 114 has a varying cross-sectional area in the plane orthogonal to the tube axis X-X′.

In some examples, the tube 104 further includes a first tube portion 124 extending along the tube axis X-X′ and including the first tube end 106 and the outlet 110 (shown in FIG. 1). In some examples, the first tube portion 124 tapers along a flow direction F from the second tube end 108 to the first tube end 106. In some examples, the first tube portion 124 at least partially defines the fluid passageway 114 therethrough.

In some examples, the first tube portion 124 includes a first tapered wall 126 disposed proximal to the first outlet end 120 and tapering inwardly relative to the tube axis X-X′ along the flow direction F, a second tapered wall 128 opposing the first tapered wall 126 and tapering inwardly relative to the tube axis X-X′ along the flow direction F, and a pair of lateral walls 130. In some examples, each of the pair of lateral walls 130 extends between the first tapered wall 126 and the second tapered wall 128. In some examples, each of the first tapered wall 126 and the second tapered wall 128 is curved. In some examples, each of the pair of lateral walls 130 is planar. However, the first tapered wall 126, the second tapered wall 128, and each of the pair of lateral walls 130 may have any other shape based on application requirements.

In some examples, the tube 104 further includes a second tube portion 132 extending along the tube axis X-X′ and comprising the second tube end 108 and the inlet 112 (shown in FIG. 2). In some examples, the second tube portion 132 includes a polygonal shape along a length L of the second tube portion 132. In some examples, the second tube portion 132 at least partially defines the fluid passageway 114 therethrough.

In some examples, the tube 104 further includes a third tube portion 134 disposed between the first tube portion 124 and the second tube portion 132 and at least partially defining the fluid passageway 114 therethrough. In some examples, the third tube portion 134 includes a pair of curved walls 136 opposing each other. In some examples, each of the pair of curved walls 136 tapers from the second tube portion 132 towards the first tube portion 124. In some examples, the third tube portion 134 further includes a pair of planar walls 138 opposing each other along and extending between the pair of curved walls 136.

The fluid nozzle 102 further includes only one guide member 140 extending from only one side 141 of the tube 104. In other words, the only one guide member 140 is disposed on only one side (i.e., the side 141) of the tube 104 and the tube axis X-X′. In some examples, the first tapered wall 126 defines the only one side 141 of the tube 104. The other side of the tube 104 at least partially defined by the second tapered wall 128 does not include any guide member. In some examples, the only one guide member 140 is connected to the first tapered wall 126. Further, a portion 143 of the only one guide member 140 extends beyond the first tube end 106 along the tube axis X-X′. In some examples, the fluid nozzle 102 includes only a single guide member 140. In other words, the fluid nozzle 102 includes not more than one guide member 140.

In some examples, the second tapered wall 128 is smooth. As used herein, the term “smooth” generally refers to a surface that is even or regular or consistent, i.e., free from any perceptible projection, lump, or indentation. The term may also mean that there are no protrusions, such as those caused by tearing off, cutting, or otherwise removing a guide member that may be integrally formed or otherwise attached to a tapered wall. In other words, the second tapered wall 128 may not include any jagged portion, e.g., from tearing-off of one of the guide members, such as in case of conventional fluid nozzle designs having dual guide members.

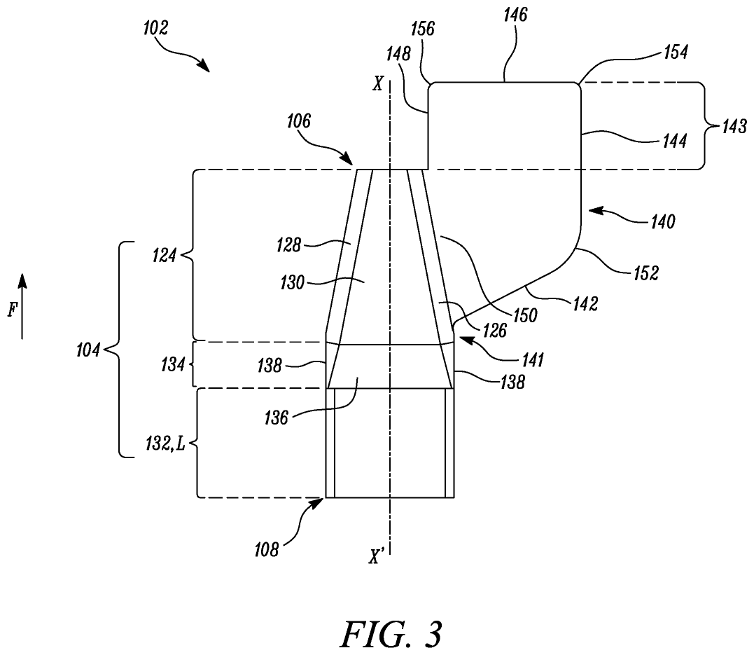

FIG. 3 illustrates a schematic front view of the fluid nozzle 102. In some examples, the only one guide member 140 includes a bottom edge 142 extending from the tube 104 towards the first tube end 106 and inclined obliquely relative to the tube axis X-X′, a first side edge 144 extending from the bottom edge 142 along the tube axis X-X′ beyond the first tube end 106, a top edge 146 extending from the first side edge 144, a second side edge 148 extending from the top edge 146 along the tube axis X-X′ to the tube 104, and a coupling portion 150 connected to and continuous with the tube 104. In some examples, the top edge 146 is spaced apart from the first tube end 106 with respect to the tube axis X-X′.

In some examples, the coupling portion 150 extends between the second side edge 148 and the bottom edge 142. In some examples, the only one guide member 140 is coupled to the tube 104 through the coupling portion 150. In some examples, the only one guide member 140 is integrally formed with the tube 104. In some examples, the only one guide member 140 may have the same material as that of the tube 104.

In some examples, the only one guide member 140 further includes a first rounded interface 152 disposed between the bottom edge 142 and the first side edge 144, a second rounded interface 154 disposed between the first side edge 144 and the top edge 146, and a third rounded interface 156 disposed between the top edge 146 and the second side edge 148.

In some examples, the second side edge 148 of the only one guide member 140 may align with an edge of a component onto which the fluid may be applied from the fluid source 116 (shown in FIG. 1) through the fluid nozzle 102. Thus, the only one guide member 140 may allow the fluid nozzle 102 to follow the edge of the component, e.g., through the portion 143, thereby guiding the fluid nozzle 102 as the fluid is applied onto the component. This may facilitate application of the fluid from the fluid source 116 (shown in FIG. 1) onto the component.

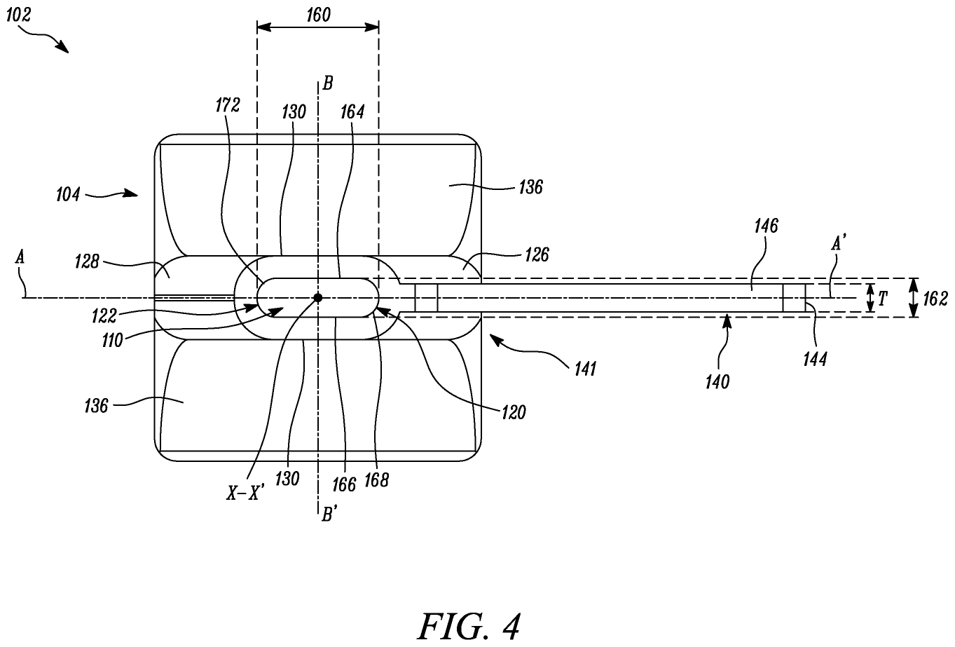

FIG. 4 illustrates a schematic top view of the fluid nozzle 102. In some examples, the tube 104 defines a first axis A-A′ orthogonal to the tube axis X-X′ and a second axis B-B′ orthogonal to each of the tube axis X-X′ and the first axis A-A′.

In some examples, the pair of lateral walls 130 of the first tube portion 124 (shown in FIGS. 1-3) oppose each other along the second axis B-B′. In some examples, the pair of curved walls 136 of the third tube portion 134 (shown in FIGS. 1-3) oppose each other along the second axis B-B′. In some examples, the pair of planar walls 138 of the third tube portion 134 (shown in FIGS. 1-3) oppose each other along the first axis A-A′.

In some examples, the outlet 110 further includes an outlet width 160 between the first outlet end 120 and the second outlet end 122 along the first axis A-A′ and an outlet height 162 along the second axis B-B′. In some examples, the outlet width 160 is greater than the outlet height 162 by a factor from about 2 to about 10. In some examples, the only one guide member 140 extends from the tube 104 along the first axis A-A′ and is aligned with the outlet width 160 of the outlet 110. In some examples, the top edge 146 of the only one guide member 140 extends along the first axis A-A′. In some examples, the only one guide member 140 has a constant thickness T along the second axis B-B′.

In some examples, the outlet 110 further includes a first longitudinal edge 164 extending along the first axis A-A′, a second longitudinal edge 166 spaced apart from the first longitudinal edge 164 with respect to the second axis B-B′ and extending along the first axis A-A′, a first curved edge 168 disposed at the first outlet end 120 and extending between the first longitudinal edge 164 and the second longitudinal edge 166, and a second curved edge 172 disposed at the second outlet end 122 and extending between the first longitudinal edge 164 and the second longitudinal edge 166. In some examples, the outlet 110 is symmetric about each of the first axis A-A′ and the second axis B-B′. Thus, the fluid nozzle 102 (including the only one guide member 140) may be used in both right-handed and left-handed orientation by the user. This is also possible since the only one guide member 140 is disposed on the only one side 141 of the tube 104.

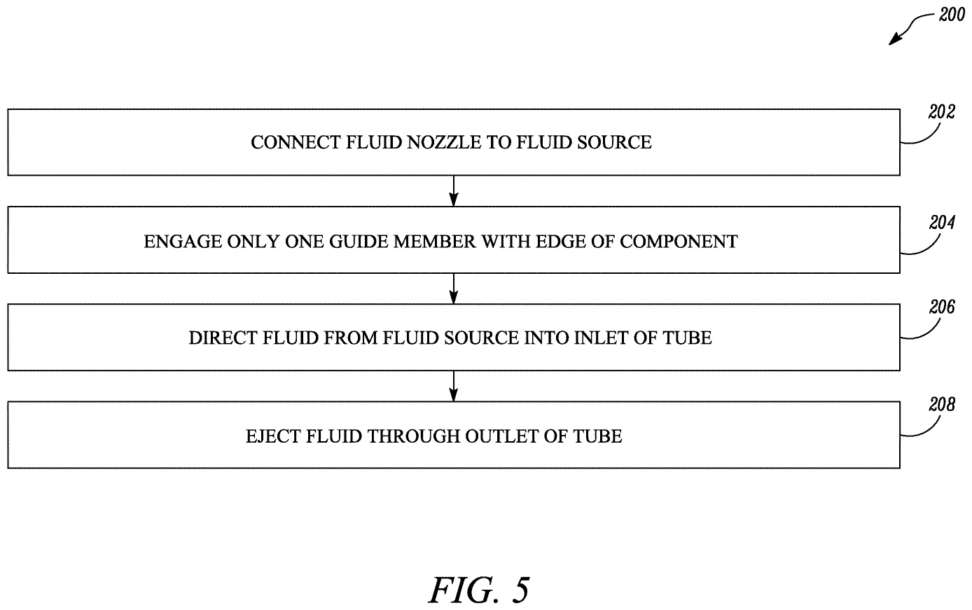

FIG. 5 is a flow chart illustrating a method 200 of using the fluid nozzle 102. The method 200 will be described hereinafter with reference to the fluid nozzle 102 of FIGS. 1-4 and FIGS. 6A-6D.

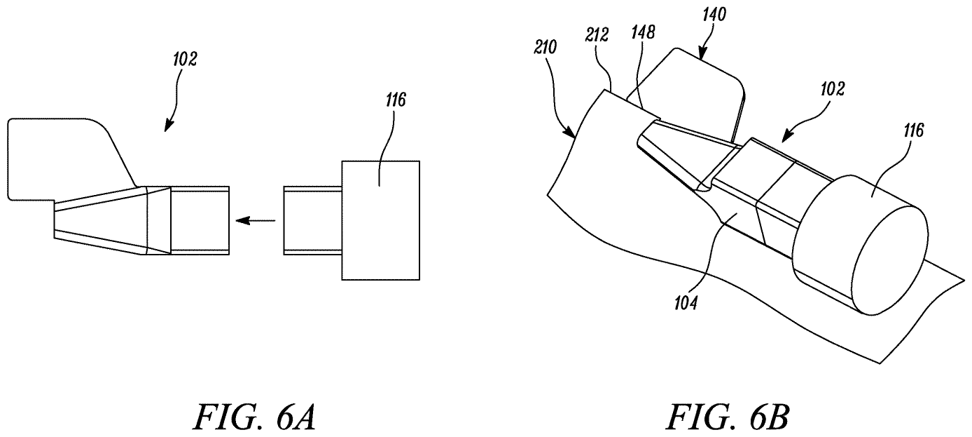

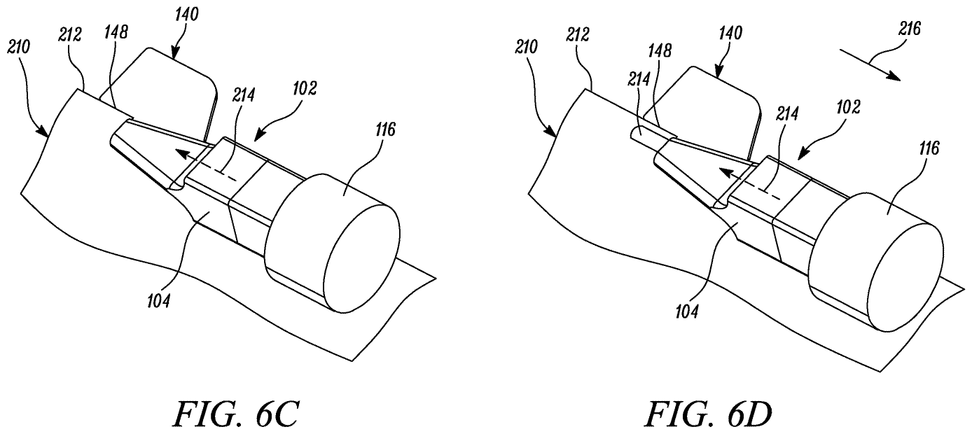

FIG. 6A illustrates a schematic side view of the fluid nozzle 102 and the fluid source 116. In FIG. 6A, the fluid source 116 is shown schematically in FIG. 1 for the purpose of illustration. Referring now to FIGS. 5 and 6A, at step 202, the method 200 includes connecting the fluid nozzle 102 to the fluid source 116. In some examples, the fluid nozzle 102 may be coupled to the fluid source 116 through a threaded engagement. It should be understood that any suitable coupling mechanisms may be utilized for coupling the fluid nozzle 102 with the fluid source 116.

FIG. 6B illustrates a schematic perspective view of the fluid nozzle 102, the fluid source 116 and a component 210. Referring now to FIGS. 5 and 6B, at step 204, the method 200 further includes engaging the only one guide member 140 with an edge 212 of the component 210. Specifically, the second side edge 148 of the only one guide member 140 is configured to engage with the edge 212 of the component 210.

FIG. 6C illustrates a schematic perspective view of the fluid nozzle 102, the fluid source 116 and the component 210 where a fluid 214 is directed from the fluid source 116 into the fluid nozzle 102. Referring now to FIGS. 5 and 6C, at step 206, the method 200 further includes directing the fluid 214 from the fluid source 116 into the inlet 112 (shown in FIG. 2) of the tube 104 of the fluid nozzle 102.

FIG. 6D illustrates a schematic perspective view of the fluid nozzle 102, the fluid source 116 and the component 210 where the fluid 214 is ejected through the fluid nozzle 102. Referring now to FIGS. 5 and 6D, at step 208, the method 200 further includes ejecting the fluid 214 through the outlet 110 (shown in FIGS. 1 & 4) of the tube 104 while moving the fluid nozzle 102 along the edge 212 of the component 210, as shown by an arrow 216.

Referring now to FIGS. 1-6D, the fluid nozzle 102 includes the only one guide member 140 extending from the only one side 141 of the tube 104 along the first axis A-A′. The only one guide member 140 may allow the fluid nozzle 102 to be aligned with the edge 212 of the component 210 onto which the fluid 214 may be applied and follow the edge 212 while the fluid 214 is extruded onto the component 210. Therefore, the only one guide member 140 may guide the fluid nozzle 102 as the fluid 214 is extruded onto the component 210.

Additionally, the outlet 110 is symmetric about each of the first axis A-A′ and the second axis B-B′, thereby allowing for the same cross-sectional profile of the outlet 110 regardless of whether the fluid nozzle 102 is being used by the user in a left-handed or a right-handed orientation. Thus, the fluid nozzle 102 of the present disclosure may reduce errors in application of the fluid 214 by providing a consistent cross-section for the outlet 110 regardless of the orientation of the fluid nozzle 102 in which the user is applying the fluid 214. This is also possible since the one only guide member 140 is disposed on only one side 141 of the tube 104. Further, the outlet 110 may allow extrusion of a consistent profile of the fluid 214 onto the component 210. The symmetric cross-section of the outlet 110 combined with the only one guide member 140 may allow reduction in a time required for the application of the fluid 214 by following the edge 212 of the component 210 as well as improve a quality of sealing.

In the present detailed description of the preferred embodiments, reference is made to the accompanying drawings, which illustrate specific embodiments in which the invention may be practiced. The illustrated embodiments are not intended to be exhaustive of all embodiments according to the invention. It is to be understood that other embodiments may be utilized, and structural or logical changes may be made without departing from the scope of the present invention. The following detailed description, therefore, is not to be taken in a limiting sense, and the scope of the present invention is defined by the appended claims.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “proximate,” “distal,” “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below or beneath other elements would then be above or on top of those other elements.

As used herein, when an element, component, or layer for example is described as forming a “coincident interface” with, or being “on,” “connected to,” “coupled with,” “stacked on” or “in contact with” another element, component, or layer, it can be directly on, directly connected to, directly coupled with, directly stacked on, in direct contact with, or intervening elements, components or layers may be on, connected, coupled or in contact with the particular element, component, or layer, for example. When an element, component, or layer for example is referred to as being “directly on,” “directly connected to,” “directly coupled with,” or “directly in contact with” another element, there are no intervening elements, components, or layers for example.

Various examples have been described. These and other examples are within the scope of the following claims.

1. A fluid nozzle comprising:
a tube comprising a first tube end and a second tube end opposite to the first tube end, the tube extending along a tube axis defined between the first tube end and the second tube end, the tube defining a first axis orthogonal to the tube axis and a second axis orthogonal to each of the tube axis and the first axis, the tube further comprising:
an outlet disposed at the first tube end, the outlet comprising a first outlet end, a second outlet end opposing the first outlet end, an outlet width between the first outlet end and the second outlet end along the first axis, and an outlet height along the second axis, wherein the outlet is symmetric about each of the first axis and the second axis, wherein the outlet further comprises a first longitudinal edge extending along the first axis, a second longitudinal edge spaced apart from the first longitudinal edge with respect to the second axis and extending along the first axis, a first curved edge disposed at the first outlet end and extending between the first longitudinal edge and the second longitudinal edge, and a second curved edge disposed at the second outlet end and extending between the first longitudinal edge and the second longitudinal edge;
an inlet disposed at the second tube end; and
a fluid passageway disposed within the tube and extending from the inlet to the outlet; and
only one guide member extending from only one side of the tube along the first axis and aligned with the outlet width of the outlet, wherein a portion of the only one guide member further extends beyond the first tube end along the tube axis, wherein the only one guide member comprises a bottom edge extending from the tube towards the first tube end and inclined obliquely relative to the tube axis, a first side edge extending from the bottom edge along the tube axis beyond the first tube end, a top edge extending from the first side edge along the first axis, a second side edge extending from the top edge along the tube axis to the tube, and a coupling portion connected to and continuous with the tube, the coupling portion extending between the second side edge and the bottom edge.

2. (canceled)

3. The fluid nozzle of claim 1, wherein the outlet width is greater than the outlet height by a factor from about 2 to about 10.

4. (canceled)

5. The fluid nozzle of claim 1, wherein the only one guide member further comprises a first rounded interface disposed between the bottom edge and the first side edge, a second rounded interface disposed between the first side edge and the top edge, and a third rounded interface disposed between the top edge and the second side edge.

6. The fluid nozzle of claim 1, wherein the top edge is spaced apart from the first tube end with respect to the tube axis.

7. The fluid nozzle of claim 1, wherein the tube further comprises:
a first tube portion extending along the tube axis and comprising the first tube end and the outlet, the first tube portion tapering along a flow direction from the second tube end to the first tube end, the first tube portion at least partially defining the fluid passageway therethrough; and
a second tube portion extending along the tube axis and comprising the second tube end and the inlet, the second tube portion comprising a polygonal shape along a length of the second tube portion, the second tube portion at least partially defining the fluid passageway therethrough.

8. The fluid nozzle of claim 7, wherein the first tube portion comprises a first tapered wall disposed proximal to the first outlet end and tapering inwardly relative to the tube axis along the flow direction, a second tapered wall opposing the first tapered wall and tapering inwardly relative to the tube axis along the flow direction, and a pair of lateral walls opposing each other along the second axis, each of the pair of lateral walls extending between the first tapered wall and the second tapered wall, wherein the first tapered wall defines the only one side of the tube, and wherein the only one guide member is connected to the first tapered wall.

9. The fluid nozzle of claim 8, wherein the second tapered wall is smooth.

10. The fluid nozzle of claim 8, wherein each of the first tapered wall and the second tapered wall is curved, and wherein each of the pair of lateral walls is planar.

11. The fluid nozzle claim 10, wherein the tube further comprises a third tube portion disposed between the first tube portion and the second tube portion and at least partially defining the fluid passageway therethrough, the third tube portion comprising:
a pair of curved walls opposing each other along the second axis, each of the pair of curved walls tapering from the second tube portion towards the first tube portion; and
a pair of planar walls opposing each other along the first axis and extending between the pair of curved walls.

12. The fluid nozzle of claim 1, wherein the only one guide member has a constant thickness along the second axis.

13. A method of using the fluid nozzle of claim 12, the method comprising:
connecting the fluid nozzle to a fluid source;
engaging the only one guide member with an edge of a component;
directing a fluid from the fluid source into the inlet of the tube of the fluid nozzle; and
ejecting the fluid through the outlet of the tube while moving the fluid nozzle along the edge of the component.

14. A fluid system comprising:
a fluid nozzle comprising:
a tube comprising a first tube end and a second tube end opposite to the first tube end, the tube extending along a tube axis defined between the first tube end and the second tube end, the tube defining a first axis orthogonal to the tube axis and a second axis orthogonal to each of the tube axis and the first axis, the tube further comprising:
an outlet disposed at the first tube end, the outlet comprising a first outlet end, a second outlet end opposing the first outlet end, an outlet width between the first outlet end and the second outlet end along the first axis, and an outlet height along the second axis, wherein the outlet is symmetric about each of the first axis and the second axis, wherein the outlet further comprises a first longitudinal edge extending along the first axis, a second longitudinal edge spaced apart from the first longitudinal edge with respect to the second axis and extending along the first axis, a first curved edge disposed at the first outlet end and extending between the first longitudinal edge and the second longitudinal edge, and a second curved edge disposed at the second outlet end and extending between the first longitudinal edge and the second longitudinal edge;
an inlet disposed at the second tube end; and
a fluid passageway disposed within the tube and extending from the inlet to the outlet; and
only one guide member extending from only one side of the tube along the first axis and aligned with the outlet width of the outlet, wherein a portion of the only one guide member further extends beyond the first tube end along the tube axis, wherein the only one guide member comprises a bottom edge extending from the tube towards the first tube end and inclined obliquely relative to the tube axis, a first side edge extending from the bottom edge along the tube axis beyond the first tube end, a top edge extending from the first side edge along the first axis, a second side edge extending from the top edge along the tube axis to the tube, and a coupling portion connected to and continuous with the tube, the coupling portion extending between the second side edge and the bottom edge; and
a fluid source connected to the fluid nozzle and disposed in fluid communication with the fluid passageway.

15. (canceled)

16. The fluid system of claim 14, further comprising a static mix nozzle that is configured to couple to the fluid source and the fluid nozzle, the static mix nozzle having a first shape profile, wherein the fluid nozzle has a second shape profile that is complementary to the first shape profile, such that the static mix nozzle is mateable with the fluid nozzle.

17. (canceled)

18. The fluid system of claim 17, wherein the only one guide member further comprises a first rounded interface disposed between the bottom edge and the first side edge, a second rounded interface disposed between the first side edge and the top edge, and a third rounded interface disposed between the top edge and the second side edge.

19. The fluid system of claim 18, wherein the top edge is spaced apart from the first tube end with respect to the tube axis.

20. The fluid system of claim 14, wherein the tube further comprises:
a first tube portion extending along the tube axis and comprising the first tube end and the outlet, the first tube portion tapering along a flow direction from the second tube end to the first tube end, the first tube portion at least partially defining the fluid passageway therethrough; and
a second tube portion extending along the tube axis and comprising the second tube end and the inlet, the second tube portion comprising a polygonal shape along a length of the second tube portion, the second tube portion at least partially defining the fluid passageway therethrough.
